(19) United States
(12) Patent Application Publication
(10) Pub. No.: US 2012/0217122 A1
(43) Pub. Date: Aug. 30, 2012

(54) VEHICLE DRIVE DEVICE

(75) Inventors: Satoru KASUYA, Nishio (JP); Masashi KITO, Anjo (JP); Shigeru SUGISAKA, Nishio (JP); Muneyuki TSUMURA, Anjo (JP); Yuichi SEKI, Okazaki (JP)

(73) Assignee: AISIN AW CO., LTD., Anjo-shi (JP)

(21) Appl. No.: 13/402,222

(22) Filed: Feb. 22, 2012

(30) Foreign Application Priority Data
Feb. 28, 2011 (JP) 2011-043381
Dec. 26, 2011 (JP) 2011-284555

(51) Int. Cl. F16D 13/72

(52) U.S. Cl. 192/113.35; 903/902

(57) ABSTRACT

A vehicle drive device comprising a friction engagement device disposed on a power transfer path between an engine and wheels and including a first friction plate drivably coupled to a power transfer path on the engine side and a second friction plate drivably coupled to a power transfer path on the wheels side, a rotary electric machine drivably coupled to the power transfer path on the wheels side, a case member including an internal space where the first and second friction plates of the friction engagement device are housed, the internal space being configured to dip the first and second friction plates in oil and a communication mechanism that regulates communication between the internal space of the case member and an external space, the communication mechanism allowing the oil to be discharged from the internal space to the external space when communication between the internal and external spaces is allowed.

### INCORPORATION BY REFERENCE

The disclosure of Japanese Patent Application No. 2011-043381 filed on Feb. 28, 2011 and Japanese Patent Application No. 2011-284555 filed on Dec. 26, 2011 including the specifications, drawings and abstracts is incorporated herein by reference in its entirety.

### BACKGROUND OF THE INVENTION

The present invention relates to a vehicle drive device mounted on a vehicle such as a hybrid automobile including an engine and a rotary electric machine as drive sources, and in particular to a vehicle drive device including a friction engagement device disposed on a power transfer path between the engine and wheels.

### DESCRIPTION OF THE RELATED ART

Rise of environmental awareness in recent years has led to intensive study on hybrid automobiles including an engine and a rotary electric machine as drive sources. Provided with the rotary electric machine as a drive source as discussed above, the hybrid automobile does not only travel using the engine, but also regenerates kinetic energy of the vehicle using the rotary electric machine and travels using only the rotary electric machine without using the engine (EV travel) to improve the energy efficiency.

In such a hybrid automobile, if the engine is connected to a drive system during EV travel in which the engine is not used, however, the engine may rotate in an accompanying manner to increase drag torque.

Thus, some vehicle drive devices include a clutch capable of allowing and blocking power transfer between the engine and the rotary electric machine so that the clutch is disengaged during EV travel to prevent the engine from rotating in an accompanying manner.

Such a clutch capable of allowing and blocking power transfer from the engine occasionally transfers power while the clutch is caused to slip, such as when the vehicle is started using the engine. In the related art, in order to sufficiently cool the clutch even on such occasions where the clutch produces a large amount of heat, it is devised to house the clutch in a liquid-tight housing (see Japanese Patent Application Publication No. 2010-196868 (JP 2010-196868 A)).

### SUMMARY OF THE INVENTION

If the clutch is housed in the liquid-tight housing as in the hybrid drive device according to JP 2010-196868 A mentioned above, heat produced by the clutch is absorbed by a liquid with a high specific heat, which facilitates securing the cooling performance required for the clutch.

Although the clutch can disconnect the engine from the drive system, disengagement of the clutch also causes a rotational speed difference between the liquid-tight housing and friction plates on the rotary electric machine side or the engine side when EV travel is performed with the clutch disposed in the liquid-tight housing as discussed above. Thus, the housing and the friction plates rotate relative to each other, which causes a resistance to stirring to increase drag torque.

It is therefore an object of the present invention to provide a vehicle drive device in which drag torque is reduced while securing the cooling performance for a friction engagement device disposed between an engine and a rotary electric machine.

According to an aspect of the present invention, a vehicle drive device includes:

a friction engagement device disposed on a power transfer path between an engine and wheels and including a first friction plate drivably coupled to a power transfer path, of the power transfer path, on the engine side and a second friction plate drivably coupled to a power transfer path on the wheels side;

a rotary electric machine drivably coupled to the power transfer path on the wheels side;

a case member including an internal space in which the first and second friction plates of the friction engagement device are housed, the internal space being configured such that the first and second friction plates can be dipped in oil; and

a communication mechanism that allows and blocks communication between the internal space of the case member and an external space, the communication mechanism allowing the oil to be discharged from the internal space to the external space when communication between the internal space and the external space is allowed.

By adopting the configuration described above, in which the friction engagement device is disposed on the power transfer path between the engine and the wheels, and in which the communication mechanism allows communication between the inside and the outside of the case member housing the friction plates of the friction engagement device, it is possible to switch the filling state of oil in the case member. That is, in the case where the friction engagement device produces a large amount of heat, the communication mechanism blocks communication between the internal space of the case member and the external space to dip the friction plates in the case member in oil, which secures the cooling performance for the friction engagement element. Meanwhile, in the case where the vehicle is driven with the friction engagement device disengaged, such as during EV travel, oil is discharged from the inside of the case member to reduce the resistance to stirring of oil performed by the friction plates, which reduces the drag torque of the vehicle drive device.

The case member may be drivably coupled to the power transfer path on the wheels side, and

the communication mechanism may be provided in the case member, and may switchably allow and block communication between the internal space of the case member and the external space on the basis of a rotational state of the case member.

By switchably allowing and blocking communication between the internal space of the case member and the external space on the basis of the rotational state of the case member as described above, the case member can be filled with oil with the communication mechanism blocking communication between the internal space of the case member and the external space in the case where the friction engagement element produces a large amount of heat, for example in the case where the vehicle is started using the engine while the friction engagement element is caused to slip. Meanwhile, oil can be discharged from the internal space of the case member in which the friction plates are housed with the communication mechanism allowing communication between the internal space of the case member and the external space in the case where the vehicle travels at a predetermined speed or higher such as during EV travel or with the friction engagement device engaged.

The communication mechanism may block communication between the internal space of the case member and the external space in the case where the rotational speed of the case member is less than a predetermined rotational speed, and may allow communication between the internal space of the case member and the external space in the case where the rotational speed of the case member is equal to or more than the predetermined rotational speed.

By switchably allowing and blocking communication through the communication mechanism in accordance with the rotational speed of the case member as described above, it is possible to automatically switch the filling state of oil in the case member between during low-speed travel when the friction engagement element often transfers power while slipping to produce a large amount of heat, such as when the vehicle is started using the engine, and during EV travel when the vehicle often travels at a certain speed or higher.

The communication mechanism may include a communication hole provided in the case member to allow communication between the internal space and the external space, and a valve element that is moved to a blocking position at which the valve element blocks the communication hole in the case where the rotational speed of the case member is less than the predetermined rotational speed, and to a retracted position at which the valve element allows communication through the communication hole using a centrifugal force in the case where the rotational speed of the case member is equal to or more than the predetermined rotational speed.

By forming the communication mechanism using the valve element which allows communication between the inside and the outside of the case member on the basis of a centrifugal force achieved when the rotational speed of the case member reaches the predetermined rotational speed as described above, the communication mechanism with a simple configuration can be manufactured inexpensively.

The first friction plate of the friction engagement device may be formed by one of an annular inner friction plate spline-engaged at an inner circumferential side thereof and an annular outer friction plate spline-engaged at an outer circumferential side thereof, and the second friction plate of the friction engagement device may be formed by the other of the inner friction plate and the outer friction plate, and

the communication mechanism may be provided in the case member at a position on a radially outer side with respect to an inner circumferential surface of the outer friction plate.

By providing the communication mechanism, which allows communication between the inside and the outside of the case member, at a position on the radially outer side with respect to the inner circumferential surface of the outer friction plate of the friction engagement device as described above, the level of oil in the case member can be lowered to a level at which at least part of the friction plates is not dipped in the oil, which reduces the resistance to stirring due to rotation of the friction plates to improve the energy efficiency of the vehicle drive device.

The communication mechanism may block communication between the internal space of the case member and the external space when a vehicle is started using a drive force of the engine in the case where the friction engagement device is caused to slip, and

the communication mechanism may allow communication between the internal space of the case member and the external space when the vehicle is driven using the rotary electric machine in the case where the second friction plate is rotationally driven by the rotary electric machine to rotate at a rotational speed equal to or more than the predetermined rotational speed with the friction engagement device disengaged.

By switchably allowing and blocking communication through the communication mechanism in accordance with the rotational speed of the case member as described above, it is possible to automatically switch the filling state of oil in the case member between during low-speed travel when the friction engagement element often transfers power while slipping to produce a large amount of heat, such as when the vehicle is started using the engine, and during EV travel when the vehicle often travels at a certain speed or higher.

The vehicle drive device may include a housing inside which the case member is housed, and

the case member may partition a space inside the housing into the internal space and the external space.

With the case member partitioning the space inside the housing into the internal space of the case member and external space as described above, it is possible to separate the internal space, in which friction plates of the friction engagement device are housed and which can be filled and unfilled with oil, from the external space, in which other constituent parts are housed.

### BRIEF DESCRIPTION OF THE DRAWINGS

FIG. 1 is a schematic diagram showing a hybrid automobile according to an embodiment of the present invention;

FIG. 2 is a schematic view showing an input section of a hybrid drive device according to the embodiment of the present invention;

FIG. 3 is a hydraulic circuit diagram showing a control valve according to the embodiment of the present invention;

FIG. 4 is a flowchart showing the state of circulation oil in a clutch housing according to the embodiment of the present invention;

FIG. 5 is a schematic view showing a modification of a communication mechanism according to the embodiment of the present invention; and

FIG. 6 is a schematic view showing another modification of the communication mechanism according to the embodiment of the present invention.

### DETAILED DESCRIPTION OF THE EMBODIMENTS

A vehicle drive device according to an embodiment of the present invention will be described below with reference to the drawings. A hybrid drive device serving as the vehicle drive device according to the embodiment of the present invention is suitably mounted on FF (front-engine front-drive) vehicles. The left-right direction in the drawings corresponds to the left-right direction with the device actually mounted on the vehicle. For convenience of description, however, the side of drive sources such as an engine is referred to as “front side”, and the side opposite the drive sources is referred to as “rear side”. The term “drivably coupled” refers to a state in which two rotary elements are coupled to each other in such a way that allows transfer of a drive force, which includes a state in which the two rotary elements are coupled to each other to rotate together with each other, and a state in which the two rotary elements are coupled to each other via one or two or more transmission members in such a way that allows transfer of a drive force. Examples of such transmission members include various members that transfer rotation at an equal speed or a changed speed, such as a shaft, a gear mechanism, a belt, and a chain.

[Schematic Configuration of Hybrid. Drive Device]

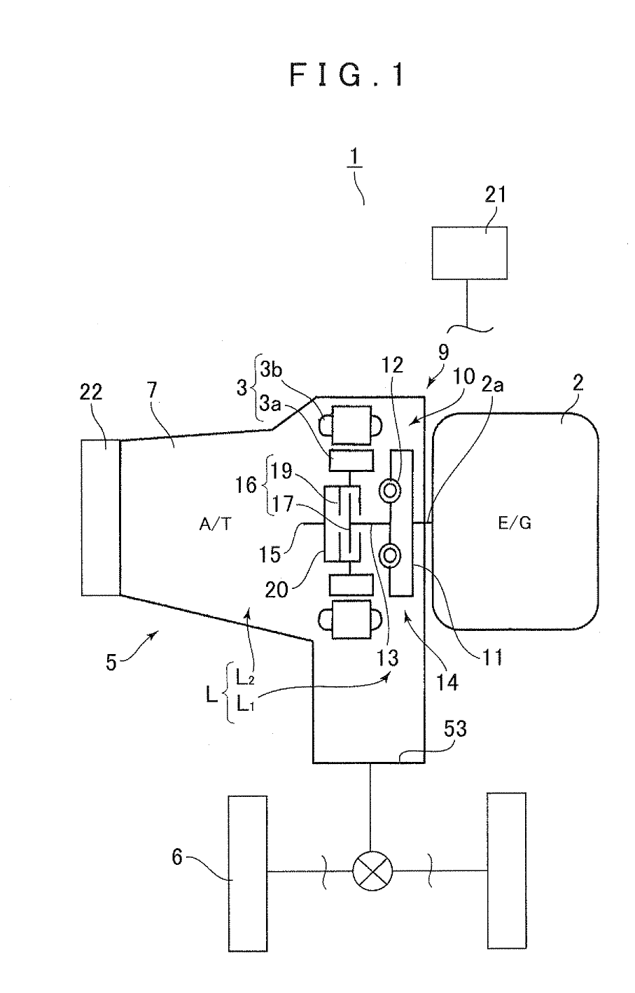

As shown in FIG. 1, a hybrid automobile 1 includes an engine 2 and a rotary electric machine (motor generator) 3 as drive sources. A hybrid drive device 5 forming a power train of the hybrid automobile 1 includes a transmission 7 provided on a power transfer path L between the engine 2 and wheels 6, and an input section 9 which is disposed between the transmission 7 and the engine 2 and to which power from the engine 2 is input.

The input section 9 includes a power transfer device 10 that transfers power between the engine 2 and the transmission 7, and the rotary electric machine 3 provided to the power transfer device 10. The power transfer device 10 is formed by a connection section 14 including a damper 12 connected to a crankshaft 2a of the engine 2 via a drive plate 11 and a connection shaft 13 with which the damper 12 is spline-fitted, and a clutch (friction engagement device) 16 that allows and blocks power transfer between the connection section 14 drivably coupled to the engine 2 and an input shaft (input section) 15 of the transmission 7 drivably coupled to the wheels 6.

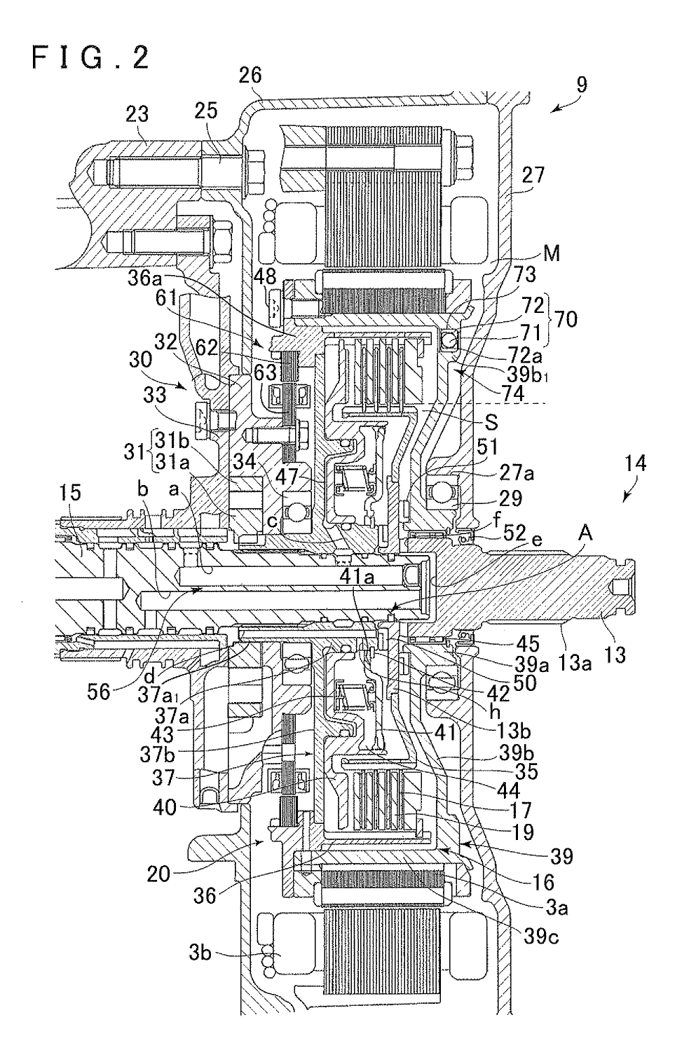

The clutch 16 is formed as a multi-plate clutch in which a plurality of inner friction plates (first friction plates) 17 and outer friction plates (second friction plates) 19 are housed in an internal space S of a clutch housing 20. The clutch housing 20 is coupled to the input shaft 15 of the transmission 7 so as to rotate together with the input shaft 15. That is, the clutch 16 includes the inner friction plates 17 drivably coupled to a member forming a power transfer path L_{I}, of the power transfer path L, on the engine side with respect to the clutch 16 (specifically, the crankshaft 2a of the engine 2, the drive plate 11, the damper 12, the connection shaft 13, a clutch hub 35, or the like shown in FIGS. 1 and 2), and the outer friction plates 19 drivably coupled to a member forming a power transfer path L₂ on the wheels side with respect to the clutch 16 (specifically, the clutch housing 20, the input shaft 15, the transmission 7, or the like shown in FIGS. 1 and 2). The clutch housing 20 itself forms the transfer path L₂ on the wheels side, and thus is drivably coupled to the power transfer path L₂ on the wheels side.

Further, the rotary electric machine 3 is disposed on the radially outer side of the clutch housing 20 so as to overlap the clutch 16 in the axial position. The rotary electric machine 3 is formed by a rotor 3a secured to the clutch housing 20 and a stator 3b disposed on the radially outer side of the rotor 3a so as to face the rotor 3a.

That is, in the hybrid drive device 5, the connection section 14, the clutch 16, the rotary electric machine 3, and the transmission 7 are arranged sequentially from the engine side to the wheels side. In the case where the vehicle is driven by driving both the engine 2 and the rotary electric machine 3, a control section 21 controls a control valve (hydraulic pressure control device) 22 to engage the clutch 16. During EV travel in which the vehicle is driven using only the drive force of the rotary electric machine 3 drivably coupled to the power transfer path L₂ on the wheels side, the clutch 16 is disengaged to disconnect the power transfer path L₁ on the engine side and the power transfer path L₂ on the wheels side from each other.

[Configuration of Input Section]

Next, the configuration of the input section 9 will be described in detail. As shown in FIG. 2, the clutch 16 and the rotary electric machine 3 are housed in a motor housing (housing) 26 fixed by a bolt 25 to a transmission case 23 housing the transmission 7. A partition wall 27 is integrally attached to the motor housing 26 to separate the space in the motor housing 26 in which the clutch 16 and the rotary electric machine 3 are housed from a portion where the engine 2 is attached.

The connection shaft 13, which is connected to the engine 2 via the damper 12, and the input shaft 15 of the transmission 7 are fittingly inserted through the center portion of the motor housing 26 so as to be coaxial with each other. The connection shaft 13 is rotatably supported by a ball bearing 29 provided in a cylindrical portion 27a of the partition wall 27.

Meanwhile, the input shaft 15 is rotatably supported by a ball bearing 34 provided in an oil pump body 32 fixed to the transmission case 23 via an oil pump cover 33.

An oil pump 30 including the oil pump body 32 is provided on the transmission side of the clutch 16, and formed from oil pump gears (rotor) 31 including a drive gear 31a and a driven gear 31b, the oil pump body 32 housing the oil pump gears 31, and the oil pump cover 33 attached to the oil pump body 32 from the transmission side.

The connection shaft 13 includes a spline portion 13a which projects from the partition wall 27 and with which the damper 12 is spline-fitted, and a flange portion 13b provided at an end portion of the connection shaft 13 on the transmission side in the motor housing to extend radially outward. The clutch hub 35 of the clutch 16 is attached to the flange portion 13b.

The clutch hub 35 is a part forming the clutch 16 which allows and blocks power transfer between the connection shaft 13, to which power from the engine 2 is transferred, and the input shaft 15 of the transmission 7. The clutch hub 35 is provided to extend so as to face a clutch drum 36 drivably coupled to the input shaft 15 via the clutch housing 20.

More specifically, the clutch drum 36 is provided to extend in the axial direction from a radially outer end portion of a rear wall portion 37b of the clutch housing 20 toward a front wall portion 39b, and disposed such that the inner circumferential surface of the clutch drum 36 positioned on the radially outer side and the outer circumferential surface of the clutch hub 35 positioned on the radially inner side face each other. The plurality of outer friction plates 19, which are formed from annular friction plates and which are spline-engaged on the outer circumferential side with the inner circumferential surface of the clutch drum 36, are provided on the inner circumferential surface of the clutch drum 36. The plurality of inner friction plates 17, which are formed from annular friction plates and which are spline-engaged on the inner circumferential side with the inner circumferential surface of the clutch hub 35, are provided on the outer circumferential surface of the clutch hub 35. The outer friction plates 19 and the inner friction plates 17 are arranged alternately.

The clutch 16 further includes a piston 40 that forms a working oil chamber 47 between the rear wall portion 37b and the piston 40, a spring retainer 41 retained on a boss portion 37a of the rear wall portion 37b by a snap ring 42, and a return spring 43 provided in a contracted state between the piston 40 and the spring retainer 41. The piston 40 presses the outer friction plates 19 and the inner friction plates 17 to engage the clutch 16.

That is, the inner friction plates 17 are drivably coupled to the connection section 14, to which power from the engine 2 is input via the connection shaft 13, so as to rotate together with the connection section 14. The outer friction plates 19 are drivably coupled to the input shaft 15 of the transmission 7 via the rear wall portion 37b of the clutch housing 20. The clutch 16 engages and disengages the inner friction plates 17 and the outer friction plates 19 with and from each other to serve as a starting clutch that allows and blocks power transfer from the engine 2 to the transmission 7.

The space on the opposite side of the piston 40 from the working oil chamber 47, that is, the space formed between the piston 40 and the spring retainer 41, serves as a cancellation oil chamber 44 that cancels a centrifugal hydraulic pressure generated in the working oil chamber 47.

The clutch housing 20 discussed above serves as a case member that partitions the space in the motor housing, in which the clutch housing 20 housing the clutch 16 is housed, into the internal space S, in which the inner friction plates 17 and the outer friction plates 19 are housed, and an external space (outside) M, in which the rotary electric machine 3 is housed. The internal space S can be filled with oil with no leakage of circulation oil.

That is, the clutch housing 20 is formed by the front wall portion (engine-side sidewall) 39b provided on the engine side of the clutch 16 to extend radially outward, the rear wall portion (transmission-side sidewall) 37b provided on the transmission side of the clutch 16 to extend radially outward, and an annular portion 39c connecting between the front wall portion 39b and the rear wall portion 37b to form a circumferential surface of the clutch housing 20, with the front wall portion 39b, the rear wall portion 37b, and the annular portion 39c integrated with each other.

Each constituent part of the clutch housing 20 is considered. The front wall portion 39b and the annular portion 39c discussed above are formed by a cylindrical member 39, which includes a boss portion 39a fitted with the connection shaft 13 via a needle bearing 45 such that the boss portion 39a and the connection shaft 13 can rotate relative to each other. Further, the boss portion 39a is interposed between the connection shaft 13 and the ball bearing 29. Therefore, one-end side of the clutch housing 20 is rotatably supported by the partition wall 27 via the ball bearing 29.

Meanwhile, the rear wall portion 37b of the clutch housing 20 is formed by a plate-like member 37 and the clutch drum 36. The plate-like member 37 is formed by a wall portion 37b provided to extend radially outward, and the boss portion 37a provided to extend forward and rearward in the axial direction across the wall portion 37b.

A portion of the boss portion 37a on the transmission side is formed as a shaft portion 37a₁, on the inner circumferential surface of which splines are formed to be spline-fitted with the input shaft 15. Further, the shaft portion 37a₁ is interposed between the ball bearing 34 and the input shaft 15. Therefore, the other-end side of the clutch housing 20 is rotatably supported by the oil pump body 32, which serves as a stationary member, via the ball bearing 34.

A drive force from the engine 2 and a drive force from the rotary electric machine 3 can be input to the shaft portion 37a₁. Therefore, the shaft portion 37a₁ also serves as a drive shaft of the oil pump 30. Key grooves formed at the distal end portion of the shaft portion 37a₁ are fitted with keys formed on the radially inner side of the drive gear 31a of the oil pump 30 so that the shaft portion 37a₁ is drivably coupled to the oil pump gears 31.

In this way, the clutch housing 20 serves as a case member housing the clutch 16, and also serves as a support member supported stably from both sides by the front wall portion 39b and the rear wall portion 37b provided across the clutch 16. That is, the clutch housing 20 is supported stably in the radial direction and the axial direction on both sides of the clutch 16 in the axial direction via the ball bearings (bearing members) 29 and 34.

Therefore, the outer circumferential surface of the annular portion 39c serves as an attachment portion for attachment of the rotor 3a of the rotary electric machine 3, to which the rotor 3a can be secured by a bolt 48.

On the radially outer side of the rotor 3a, the stator 3b is secured to the motor housing 26 so as to face the rotor 3a. The rotor 3a and the stator 3b form the rotary electric machine 3.

Further, a rotor (excitation coil) 62 of a resolver 61 that detects rotation of the rotary electric machine 3 is attached at a transmission-side end portion 36a of the clutch drum 36 forming the attachment portion together with the annular portion 39c. A stator (detection coil) 63 is secured to the oil pump body 32 positioned on the radially inner side of the rotor 62.

While the clutch housing 20 is supported in the radial direction and the axial direction by the ball bearings 29 and 34, the clutch housing 20 may be supported in the radial direction by a needle bearing and supported in the axial direction by a thrust bearing.

[Configuration of Oil Passages]

Next, the configuration of oil passages in the input section 9 will be described. A plurality of oil passages a and b, to which a hydraulic pressure regulated by the control valve 22 is supplied, are formed in the input shaft 15 of the transmission 7. A control pressure for the clutch 16 is supplied to the oil passage a.

An oil passage c, which is connected to the working oil chamber 47 of the clutch 16, is formed in the boss portion 37a of the rear wall portion 37b of the clutch housing 20. The oil passages a and c, the working oil chamber 47, and so forth form a hydraulic servo 56 for the clutch 16.

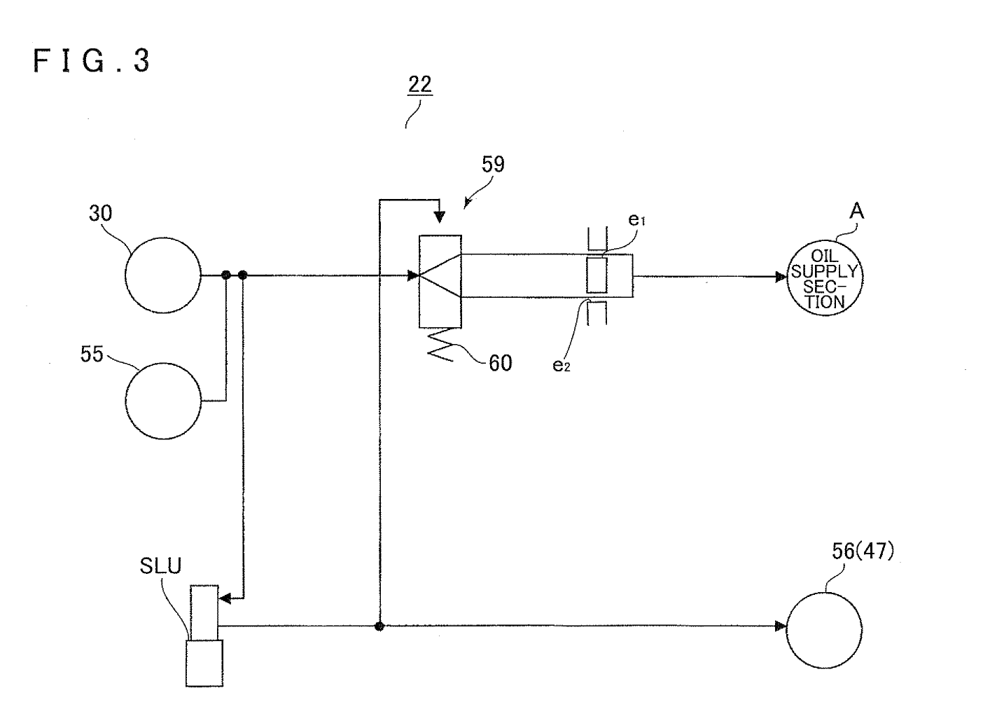

Further, an oil passage d, to which circulation oil (oil) for cooling the clutch to be supplied to the internal space S of the clutch housing 20 is supplied, is formed in the boss portion 37a of the rear wall portion 37 to extend along the input shaft 15. An oil supply section A that supplies circulation oil to the internal space S of the clutch housing 20 is formed by the oil pump 30 serving as a hydraulic pressure generation source and a supply oil passage that guides oil discharged from the oil pump 30 to the internal space S of the clutch housing 20. In the embodiment, an electric oil pump 55 shown in FIG. 3 is provided in addition to the mechanical oil pump 30 discussed above as a hydraulic pressure generation source so that the control pressure for the clutch 16 and the flow rate of circulation oil in the clutch housing 20 can be secured even when the vehicle is stationary or is to be started.

The oil passage d serving as a supply oil passage for circulation oil is connected to the internal space S of the clutch housing 20 through a clearance kept by a thrust bearing 50 interposed between the flange portion 13b of the connection shaft 13 and the boss portion 37a of the rear wall portion 37b.

The oil passage b in the input shaft 15 serves as a discharge oil passage through which circulation oil is discharged from the internal space S of the clutch housing 20. The oil passage b is connected to the internal space S of the clutch housing 20 via an oil passage f provided in the connection shaft 13 and a clearance e between the input shaft 15 and the connection shaft 13.

Therefore, circulation oil supplied from the oil passage d to the internal space S passes through the thrust bearing 50 and a clearance between the spring retainer 41 and the clutch hub 35 to cool the inner friction plates 17 and the outer friction plates 19 from the radially inner side of the clutch 16. Then, circulation oil having cooled the friction plates 17 and 19 of the clutch 16 passes through a clearance between the front wall portion 39b and the clutch hub 35 and a clearance between the flange portion 13b and the front wall portion 39b of the clutch housing 20 retained by a thrust bearing 51 to be discharged from the oil passage f, which is positioned on the opposite side of the clutch hub 35 from the oil passage through which circulation oil was supplied.

Circulation oil filling the internal space S passes through a clearance between the connection shaft 13 and the boss portion 39a of the front wall portion 39b and a clearance between the front wall portion 39b and the partition wall 27 to be discharged also to the external space M outside the clutch housing 20 while lubricating the needle bearing 45 and the ball bearing 29. Circulation oil discharged to the external space M flows back to an oil pan 53 (see FIG. 1) provided below the motor housing 26.

In this way, the internal space S housing the inner friction plates 17 and the outer friction plates 19 is configured such that circulation oil supplied from the radially inner side through the supply oil passage b can be collected in the internal space S of the clutch housing 20 so that the inner friction plates 17 and the outer friction plates 19 can be dipped in the collected circulation oil. The inner friction plates 17 and the outer friction plates 19 are configured to be cooled by circulation oil filled in the internal space S.

The space between the connection shaft 13 and the partition wall 27 is sealed by an oil seal 52 to prevent circulation oil discharged to the external space M from leaking out of the case. In addition, oil is supplied to the cancellation oil chamber 44 via the oil passage d and an oil passage h.

[Configuration of Control Valve]

Next, the configuration of a portion of the control valve 22 related to the supply of circulation oil to the oil supply section A will be described.

As shown in FIG. 3, the control valve 22 includes a linear solenoid valve SLU and a circulation amount regulation valve 59 that adjusts the supply amount of circulation oil to be supplied to the oil supply section A. The linear solenoid valve SLU is configured to regulate the control pressure to be supplied to the hydraulic servo 56 for the clutch 16 on the basis of an SLU command value output from the control section 21 in accordance with torque required from a driver so as to control engagement and disengagement of the clutch 16.

The circulation amount regulation valve 59 is a switching valve that switches between oil passages through which circulation oil is supplied to the oil supply section A. The circulation amount regulation valve 59 includes a spring 60 that urges a spool (not shown) toward one side. A control pressure from the linear solenoid valve SLU is input to the circulation amount regulation valve 59 so as to move the spool in a direction that is opposite the direction in which the urging force of the spring 60 acts.

The spring 60 urges the spool so as to block communication through a first oil passage e₁ and allow communication through a second oil passage e₂, of first and second oil passages e₁ and e₂ between which the circulation amount regulation valve 59 selectively switches. The first oil passage e₁ has a larger oil passage diameter to provide a larger amount of circulation oil to the oil supply section A compared to the second oil passage e₂. The second oil passage e₂ has a smaller oil passage diameter to provide a smaller amount of circulation oil to the oil supply section A compared to the first oil passage e₁.

Therefore, in the case where the clutch 16 is disengaged and a control pressure is not input from the linear solenoid valve SLU, the circulation amount regulation valve 59 allows communication through the second oil passage e₂, which supplies a smaller amount of circulation oil, using the urging force of the spring. In the case where a control pressure equal to or more than a predetermined pressure is output from the linear solenoid valve SLU to engage the clutch 16, meanwhile, the circulation amount regulation valve 59 allows communication through the first oil passage e₁, which supplies a larger amount of circulation oil.

[Configuration of Communication Mechanism]

Next, a communication mechanism that allows communication between the inside and the outside of the clutch housing 20 will be described.

As shown in FIG. 2, a radially outer end portion 39b₁ of the front wall portion 39b of the clutch housing 20 is formed as a thick-walled portion formed to be thicker than a portion on the radially inner side. In the thick-walled portion, a plurality of communication holes 73 that allow communication between the internal space S of the clutch housing 20 and the external space M outside the clutch housing 20 are provided at predetermined intervals in the circumferential direction.

A ball valve 70 that selectively allows communication between the inside and the outside of the clutch housing 20 on the basis of a centrifugal force is attached to each of the plurality of communication holes 73. The ball valve 70 is formed by a check ball (valve element) 71 that blocks the communication hole 73 and a case 72 housing the check ball 71.

That is, a tapered surface 72a inclined to be narrower from the inner side toward the outer side of the clutch housing 20 is formed at an end portion of the case 72 on the external space side. The ball valve 70 is configured to be opened and closed with the check ball 71 moving along the tapered surface 72a on the basis of the balance between a hydraulic pressure and a centrifugal force applied to the check ball 71.

Specifically, in the case where a rotational speed rᵢₙ of the clutch housing 20 is less than a set predetermined rotational speed rₚᵣₑ, the centrifugal force applied to the check ball 71 is relatively small compared to the centrifugal hydraulic pressure applied from circulation oil to the check ball 71. Therefore, the check ball 71 is moved to the external space side along the tapered surface 72a to a blocking position at which the check ball 71 blocks the communication hole 73.

When the rotational speed of the input shaft 15 becomes equal to or more than the set predetermined rotational speed, meanwhile, the centrifugal force applied to the check ball 71 becomes relatively large compared to the centrifugal hydraulic pressure. Thus, the check ball 71 is retracted to the internal space side along the inclination of the tapered surface 72a to a retracted position at which communication between the inside and the outside of the clutch housing 20 is allowed and the internal space S is open to the atmosphere.

A communication mechanism 74 that selectively allows communication between the inside and the outside of the clutch housing 20 using the communication hole 73, the check ball 71, and the case 72 is formed in the clutch housing (case member) 20. In the ball valve 70, the tapered surface 72a serving as a seating surface for the check ball 71 may be formed on the communication hole 73. The communication mechanism 74 may include at least the communication hole 73 and the check ball 71 that blocks the communication hole 73.

The rotational speed (release rotational speed) rₚᵣₑ at which the ball valve 70 is opened and closed may be set as desired with the inclination of the tapered surface 72a, and is set such that the communication hole 73 is blocked when the clutch 16 is slipping, and such that communication between the inside and the outside of the clutch housing 20 is allowed when the clutch 16 is disengaged.

More specifically, in the embodiment, the release rotational speed rₚᵣₑ is set to a value around the idling rotational speed of the engine 2 so that communication between the inside and the outside of the clutch housing 20 is blocked when the vehicle is started using the engine 2 and when the vehicle is traveling at a low speed using the engine 2, that is, when the clutch 16 rotates while slipping to produce a large amount of heat, and so that the internal space S of the clutch housing 20 is open to the atmosphere otherwise.

In other words, the communication mechanism 74 blocks communication between the internal space S of the clutch housing 20 and the external space M when the vehicle is started using a drive force of the engine 2 and in the case where the clutch 16 is caused to slip, and the communication mechanism 74 allows communication between the internal space S of the clutch housing 20 and the external space M when the vehicle is driven using the rotary electric machine 3 and in the case where the outer friction plates 19 are rotationally driven by the rotary electric machine 3 to rotate at a rotational speed equal to or more than the predetermined rotational speed rₚᵣₑ with the clutch 16 disengaged.

The communication mechanism 74 provided in the clutch housing 20 may be able to switchably allow and block communication between the internal space S of the clutch housing 20 and the external space M on the basis of the rotational state of the clutch housing 20. The term “rotational state” refers to a state related to rotation of the clutch housing 20 such as rotational speed and acceleration of the clutch housing 20.

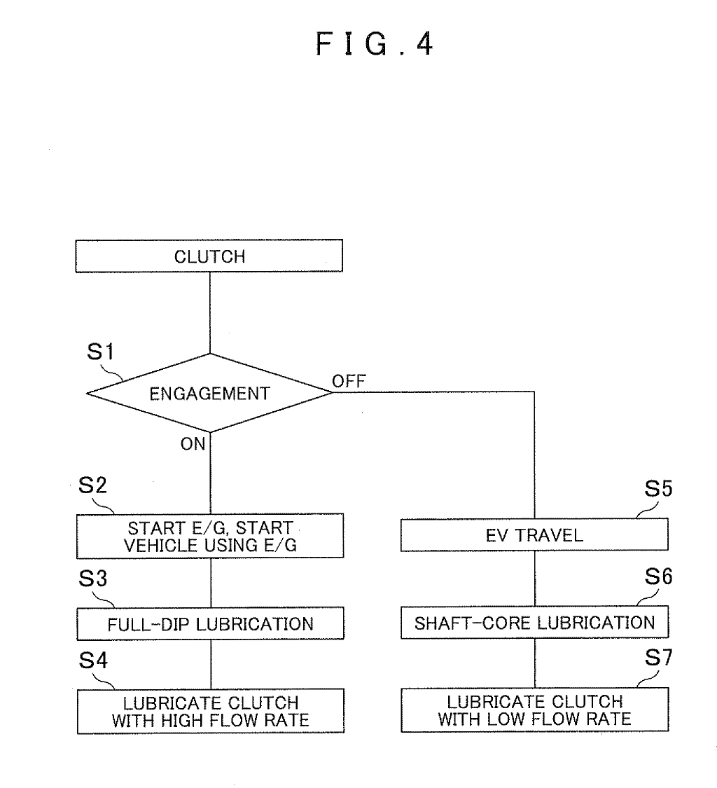

Next, the effect of the embodiment of the present invention will be described with reference to FIG. 4. When the driver depresses an accelerator pedal to start the vehicle in the case where the battery capacity is low, for example, the control section 21 increases a command value for the linear solenoid valve SLU to start the vehicle using the engine 2 while allowing the inner friction plates 17 and the outer friction plates 19 of the clutch 16 to rotate while slipping with respect to each other so that no shock is caused (S1 and S2 of FIG. 4).

When the command value for the linear solenoid valve SLU is increased and a clutch control pressure output from the linear solenoid valve SLU is increased, the circulation amount regulation valve 59 switches the supply oil passage through which circulation oil is supplied to the oil supply section A from the second oil passage e₂ to the first oil passage e₁, which increases the amount of circulation oil to be supplied to the internal space S of the clutch housing 20.

Further, in the case where the clutch 16 is in the half-engaged state, power from the engine 2 is not completely transferred to the input shaft 15 of the transmission 7. Therefore, the rotational speed rᵢₙ of the clutch housing 20 drivably coupled to the input shaft 15 of the transmission 7 is lower than the release rotational speed rₚᵣₑ for the ball valve 70 (rᵢₙ<rₚᵣₑ), and communication between the inside and the outside of the clutch housing 20 is blocked by the ball valve 70.

Therefore, circulation oil is rapidly supplied to the internal space S of the clutch housing 20, and the friction plates 17 and 19 of the clutch 16 are caused to rotate while slipping with the internal space S filled with circulation oil, which circulates at a high circulation speed to cool the clutch 16 well (S3 and S4).

When the clutch 16 is engaged and the friction plates 17 and 19 do not rotate while slipping any more, the rotational speed of the clutch housing 20 is increased to become higher than the release rotational speed rₚᵣₑ (rᵢₙ>rₚᵣₑ), which brings the ball valve 70 into the communicating state.

When the ball valve 70 is brought into the communicating state, the internal space S of the clutch housing 20 becomes open to the atmosphere, and the communication hole 73 of the clutch housing 20 which has been blocked by the check ball 71 of the ball valve 70 becomes open. Therefore, circulation oil in the internal space S is discharged from the communication hole 73, and air is introduced from the external space M outside the clutch housing 20 into the internal space S.

Therefore, generally all the circulation oil is discharged from the internal space to make the space inside the clutch housing 20 empty. The vehicle continues to travel with the space inside the clutch housing 20 empty.

Meanwhile, when the rotational speed of the clutch housing 20 becomes less than a value around the idling rotational speed of the engine 2 because the vehicle is caught in a traffic jam, for example, the clutch 16 starts slipping again.

When the rotational speed rᵢₙ of the clutch housing 20 becomes less than the release rotational speed rₚᵣₑ (rᵢₙ<rₚᵣₑ), the ball valve 70 which has been open becomes closed to tightly seal the space inside the clutch housing 20.

Then, circulation oil is supplied from the oil supply section A to the closed internal space of the clutch housing 20. Therefore, the internal space S is rapidly filled with circulation oil.

When an EV travel mode is established so that the vehicle starts traveling using only the rotary electric machine 3 without using the engine 2, meanwhile, the clutch 16 is disengaged. Therefore, a control pressure from the linear solenoid valve SLU is not input to the circulation amount regulation valve 59, and the supply oil passage through which circulation oil is supplied to the oil supply section A is switched from the first oil passage e₁ to the second oil passage e₂, which decreases the amount of circulation oil to be supplied to the internal space S of the clutch housing 20.

When the rotational speed of the clutch housing 20 becomes higher than the release rotational speed rₚᵣₑ (rᵢₙ>rₚᵣₑ), the ball valve 70 is brought into the communicating state, and the communication hole 73 of the clutch housing 20 which has been blocked by the check ball 71 of the ball valve 70 becomes open.

Consequently, circulation oil in the internal space S is discharged from the communication hole 73, and air is introduced from the external space M outside the clutch housing 20 into the internal space S, which makes the internal space S of the clutch housing 20 empty (S5 to S7).

With the hybrid drive device 5 configured as discussed above, it is possible to switch the filling state of oil in the clutch housing 20 using the ball valve 70 depending on the situation. That is, in the case where power of the engine 2 is transferred with the clutch 16 rotating while slipping, such as when the vehicle is started using the engine 2 or caught in a traffic jam, the clutch produces a large amount of heat. Therefore, the cooling performance for the clutch 16 can be enhanced by closing the ball valve 70 to fill the internal space S of the clutch housing 20 with oil.

In the case where the clutch 16 is disengaged, such as during EV travel, and when the rotational speed of the clutch housing 20 is equal to or more than the release rotational speed of the ball valve 70, the ball valve 70 is released to discharge circulation oil in the clutch housing 20, which makes the internal space S empty. This eliminates the resistance to stirring of circulation oil due to relative rotation between the inner friction plates 17 of the clutch 16 and the clutch housing 20, which improves the energy efficiency of the hybrid drive device 5.

Further, also when the dutch 16 is engaged, and in the case where the rotational speed of the clutch housing 20 is higher than the release rotational speed of the ball valve 70, circulation oil in the internal space of the clutch housing 20 can be discharged. This reduces the weight (inertia) of components in the clutch housing, and hence reduces the drive force for rotating the clutch housing 20 as a unit, which improves the energy efficiency of the hybrid drive device S.

The ball valve 70 is provided at the radially outer end portion of the front wall portion 39b of the clutch housing 20. Therefore, all the circulation oil in the internal space S of the clutch housing 20 can be discharged to eliminate the resistance to stirring of circulation oil discussed above.

Further, by switchably allowing and blocking communication through the ball valve 70 in accordance with the rotational speed of the clutch housing 20 of the transmission 7, it is possible to automatically switch the filling state of circulation oil in the clutch housing 20 between during low-speed travel when the clutch 16 often transfers power while slipping to produce a large amount of heat, such as when the vehicle is started using the engine 2, and during EV travel when the vehicle often travels at a certain speed or higher.

By controlling communication between the inside and the outside of the clutch housing 20 using the ball valve 70 which opens and closes on the basis of a centrifugal force, it is possible to form the communication mechanism that allows communication between the inside and the outside of the clutch housing 20 with a simple configuration.

Further, the supply amount of circulation oil to be supplied to the oil supply section A can be adjusted by the circulation amount regulation valve 59. Therefore, in the case where the clutch 16 produces a large amount of heat, circulation oil can be rapidly supplied to the space inside the clutch housing 20. In the case where it is only necessary to supply a small amount of circulation oil to the space inside the clutch housing 20, the supply amount of circulation oil can be reduced to reduce consumption of oil.

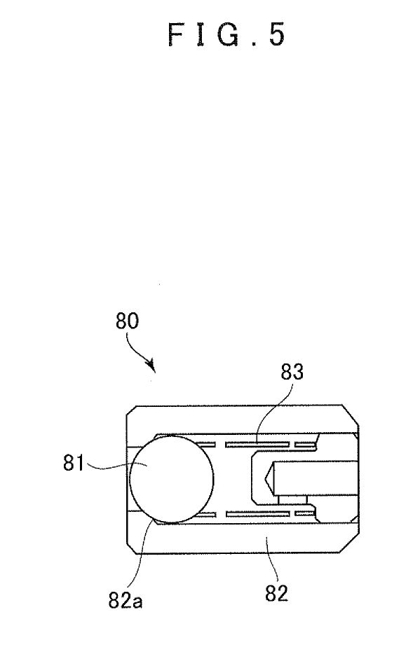

In the embodiment, the communication mechanism is formed by the ball valve 70. Besides an oil passage for circulating circulation oil, however, the communication mechanism may be configured in any manner as long as it discharges circulation oil in the internal space of the clutch housing 20. For example, as shown in FIG. 5, the communication mechanism may be formed by a ball valve 80 in which a check ball (valve element) 81 is urged by a spring 83 toward a tapered surface 82a. In the case where the ball valve 80 is used, the ball valve 80 is preferably attached to the annular portion 39c of the clutch housing 20 with the tapered surface 82a directed radially inward.

Besides a valve in which the position of the valve element that controls the flow of oil through the communication hole is controlled using a centrifugal hydraulic pressure generated on the basis of a centrifugal force due to rotation of the clutch housing 20, such as the ball valves 70 and 80 discussed above, the communication mechanism may be formed by a valve that directly switches the position of the valve element between a communicating position and a blocking position using the centrifugal force of the clutch housing 20.

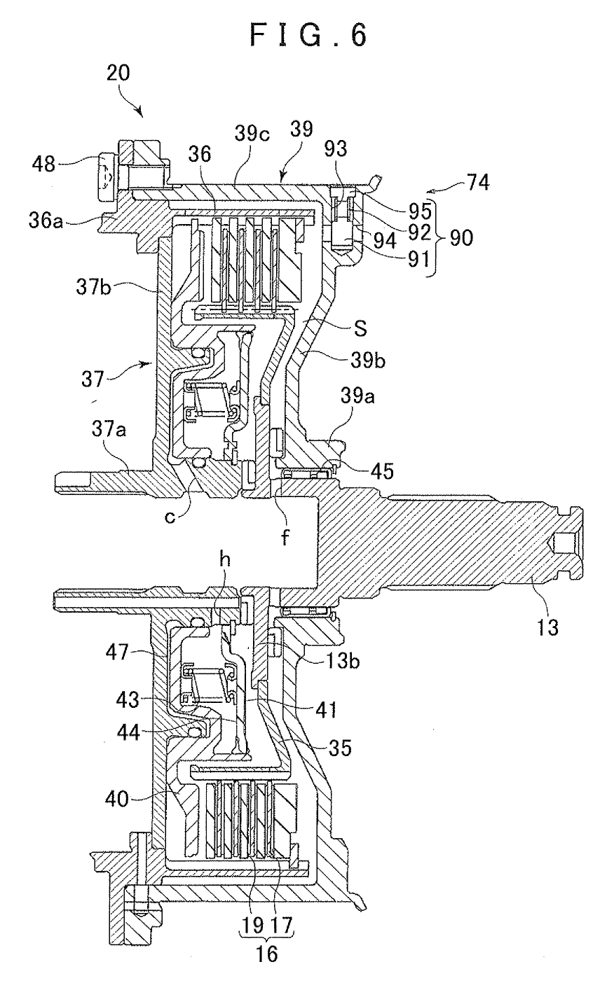

Specifically, as shown in FIG. 6, the communication mechanism may be formed by a stop valve 90 provided in an attachment hole 93 formed to extend radially inward from the annular portion 39c of the clutch housing 20 so as to cross a communication hole 94 formed to extend in the axial direction in the thick-walled portion on the radially outer side of the front wall portion 39b of the clutch housing 20 so as to communicate between the internal space S of the clutch housing 20 and the external space M.

In the stop valve 90, unlike the ball valves 70 and 80, the valve element which controls the flow of oil through the communication hole 94 is formed by a cylindrical blocking member 91. The stop valve 90 includes the blocking member 91 inserted into the attachment hole 93 so as to block the communication hole 94, a cap member 95 that lids the attachment hole 93 from the radially outer side, and a spring 92 provided in a contracted state between the cap member 95 and the blocking member 91 to urge the blocking member 91 to the radially inner side (blocking position side).

Therefore, the blocking member 91 of the stop valve 90 is moved along the attachment hole 93 in the radial direction in accordance with the balance between the radially inward urging force of the spring 92 and a centrifugal force generated by rotation of the clutch housing 20. That is, in the case where the rotational speed of the clutch housing 20 is less than a predetermined release rotational speed, the urging force of the spring 92 is larger than the centrifugal force so that the blocking member 91 is urged radially inward to a blocking position at which the blocking member 91 blocks the communication hole 94. When the rotational speed of the clutch housing 20 is equal to or more than the release rotational speed, meanwhile, the centrifugal force becomes larger than the urging force of the spring 92 so that the blocking member 91 is moved radially outward to a communicating position. Then, when the blocking member 91 is moved radially outward, the communication hole 91 is unblocked to allow oil in the internal space S of the clutch housing 20 to be discharged to the external space M via the communication hole 94.

In this way, the stop valve 90 is configured such that the blocking member 91 serving as a valve element does not receive a pressure (centrifugal hydraulic pressure) from oil inside the clutch housing 20 in the direction of movement of the blocking member 91. Therefore, the blocking member 91 is moved in accordance with the balance between the centrifugal force and the urging force of the spring 91. Thus, the position of the blocking member 91 can be switched between the communicating position and the blocking position on the basis of a centrifugal force with little influence of fluctuations in hydraulic pressure in the internal space S of the clutch housing 20 due to engagement and disengagement of the clutch 16 in the clutch housing 20, for example.

In the embodiment, the spring 83, 92 is used as an urging member that urges the valve element 81, 91. However, it is a matter of course that any elastic body such as rubber may also be used.

Further, the communication mechanism may be formed by a configuration in which the communication hole 73 is blocked in conjunction with the piston 40 of the clutch 16, or may be formed by a shutter. Alternatively, the rotational speed or the acceleration of a rotary element in the power transfer path on the wheels 6 side may be detected, and part of the communication mechanism may be provided on the motor housing 26 side, rather than on the clutch housing 20 side, so that whether communication between the internal space S of the clutch housing 20 and the external space M is allowed or blocked is controlled from the motor housing 26 side on the basis of the rotational state of the clutch housing 20 such as the detected rotational speed or acceleration.

Further, whether the communication mechanism is opened or closed may be controlled electrically depending on the situation such that the communication mechanism is closed in the case where high cooling performance is required and the communication mechanism is opened otherwise.

It is only necessary that the ball valve 70 should be provided at least at a position on the radially outer side with respect to an inner circumferential surface (radially inner end portion) 1 of the outer friction plates 19 so that an increase in drag torque due to stirring of circulation oil performed by the friction plates 17 and 19 can be reduced to any degree.

Further, the ball valve 70 may be provided in the rear wall portion 37b of the clutch housing 20, and any number of ball valves 70 may be provided.

The inner friction plates 17 may be drivably coupled to one of a rotary element in the power transfer path L₁ on the engine side, such as the clutch hub 35, and a rotary element in the power transfer path L₂ on the wheels side, such as the clutch drum 36. The outer friction plates 19 may be drivably coupled to the other of a rotary element in the power transfer path L₁ on the engine side and a rotary element in the power transfer path L₂ on the wheels side. The clutch 16 may be formed as a single-plate clutch.

Further, while the clutch 16 is used as a friction engagement element in the embodiment, a brake may be used in place of the clutch. A clutch is a component that transfers power between two rotary elements with a rotational speed difference while causing friction plates to rotate while slipping to transfer power while absorbing the rotational speed difference between the two rotary elements. A brake is a component including friction plates attached to a stationary member to brake rotation of a rotary element.

The transmission 7 may be any type of speed change mechanism. For example, the transmission 7 may be formed by a multi-speed automatic transmission or a CVT, for example, or may be formed by a transmission formed by providing the transmission 7 itself with a rotary electric machine.

Further, it is only necessary that the rotary electric machine 3 and the clutch 16 should be drivably coupled to a rotary element of the transmission 7. For example, the rotary electric machine 3 and the clutch 16 may be drivably coupled to the input shaft and the output shaft of the transmission 7.

The rotational speed of the input shaft 15 may be controlled by the transmission 7, and opening and closing of the communication mechanism may be positively controlled in accordance with the rotational speed of the input shaft 15. For example, in the case where the engine 2 is restarted through drive of the rotary electric machine 3, the transmission 7 may control the rotational speed of the input shaft 15 to a rotational speed less than the release rotational speed.

Further, the present invention may be applied not only to FF hybrid automobiles but also to FR hybrid automobiles, and may be applied to any vehicle that includes an engine and a rotary electric machine as drive sources.

It is a matter of course that the inventions described in the embodiment discussed above may be combined with each other in any combination.

The vehicle drive device according to the present invention can be used as a vehicle drive device to be mounted on a hybrid vehicle including an engine and a rotary electric machine serving as drive sources, and is particularly suitable for use as a vehicle drive device including a friction engagement device provided on a power transfer path between the engine and the rotary electric machine.

1. (canceled)

2. (canceled)

3. (canceled)

4. (canceled)

5. (canceled)

6. (canceled)

7. (canceled)

8. A vehicle drive device comprising;
a friction engagement device disposed on a power transfer path between an engine and wheels and including a first friction plate drivably coupled to a power transfer path, of the power transfer path, on the engine side and a second friction plate drivably coupled to a power transfer path on the wheels side;
a rotary electric machine drivably coupled to the power transfer path on the wheels side;
a case member including an internal space in which the first and second friction plates of the friction engagement device are housed, the internal space being configured such that the first and second friction plates can be dipped in oil; and
a communication mechanism that allows and blocks communication between the internal space of the case member and an external space, the communication mechanism allowing the oil to be discharged from the internal space to the external space when communication between the internal space and the external space is allowed.

9. The vehicle drive device according to claim 8, wherein
the case member is drivably coupled to the power transfer path on the wheels side, and
the communication mechanism is provided in the case member, and switchably allows and blocks communication between the internal space of the case member and the external space on the basis of a rotational state of the case member.

10. The vehicle drive device according to claim 8, wherein
the communication mechanism blocks communication between the internal space of the case member and the external space in the case where the rotational speed of the case member is less than a predetermined rotational speed, and allows communication between the internal space of the case member and the external space in the case where the rotational speed of the case member is equal to or more than the predetermined rotational speed.

11. The vehicle drive device according to claim 9, wherein
the communication mechanism blocks communication between the internal space of the case member and the external space in the case where the rotational speed of the case member is less than a predetermined rotational speed, and allows communication between the internal space of the case member and the external space in the case where the rotational speed of the case member is equal to or more than the predetermined rotational speed.

12. The vehicle drive device according to claim 10, wherein
the communication mechanism includes a communication hole provided in the case member to allow communication between the internal space and the external space, and a valve element that is moved to a blocking position at which the valve element blocks the communication hole in the case where the rotational speed of the case member is less than the predetermined rotational speed, and to a retracted position at which the valve element allows communication through the communication hole using a centrifugal force in the case where the rotational speed of the case member is equal to or more than the predetermined rotational speed.

13. The vehicle drive device according to claim 11, wherein
the communication mechanism includes a communication hole provided in the case member to allow communication between the internal space and the external space, and a valve element that is moved to a blocking position at which the valve element blocks the communication hole in the case where the rotational speed of the case member is less than the predetermined rotational speed, and to a retracted position at which the valve element allows communication through the communication hole using a centrifugal force in the case where the rotational speed of the case member is equal to or more than the predetermined rotational speed.

14. The vehicle drive device according to claim 8, wherein
the first friction plate of the friction engagement device is formed by one of an annular inner friction plate spline-engaged at an inner circumferential side thereof and an annular outer friction plate spline-engaged at an outer circumferential side thereof, and the second friction plate of the friction engagement device is formed by the other of the inner friction plate and the outer friction plate, and
the communication mechanism is provided in the case member at a position on a radially outer side with respect to an inner circumferential surface of the outer friction plate.

15. The vehicle drive device according to claim 10, wherein
the communication mechanism blocks communication between the internal space of the case member and the external space when a vehicle is started using a drive force of the engine in the case where the friction engagement device is caused to slip, and
the communication mechanism allows communication between the internal space of the case member and the external space when the vehicle is driven using the rotary electric machine in the case where the second friction plate is rotationally driven by the rotary electric machine to rotate at a rotational speed equal to or more than the predetermined rotational speed with the friction engagement device disengaged.

16. The vehicle drive device according to claim 11, wherein
the communication mechanism blocks communication between the internal space of the case member and the external space when a vehicle is started using a drive force of the engine in the case where the friction engagement device is caused to slip, and
the communication mechanism allows communication between the internal space of the case member and the external space when the vehicle is driven using the rotary electric machine in the case where the second friction plate is rotationally driven by the rotary electric machine to rotate at a rotational speed equal to or more than the predetermined rotational speed with the friction engagement device disengaged.

17. The vehicle drive device according to claim 12, wherein
the communication mechanism blocks communication between the internal space of the case member and the external space when a vehicle is started using a drive force of the engine in the case where the friction engagement device is caused to slip, and
the communication mechanism allows communication between the internal space of the case member and the external space when the vehicle is driven using the rotary electric machine in the case where the second friction plate is rotationally driven by the rotary electric machine to rotate at a rotational speed equal to or more than the predetermined rotational speed with the friction engagement device disengaged.

18. The vehicle drive device according to claim 13, wherein
the communication mechanism blocks communication between the internal space of the case member and the external space when a vehicle is started using a drive force of the engine in the case where the friction engagement device is caused to slip, and
the communication mechanism allows communication between the internal space of the case member and the external space when the vehicle is driven using the rotary electric machine in the case where the second friction plate is rotationally driven by the rotary electric machine to rotate at a rotational speed equal to or more than the predetermined rotational speed with the friction engagement device disengaged.

19. The vehicle drive device according to claim 8, further comprising:
a housing inside which the case member is housed, wherein
the case member partitions a space inside the housing into the internal space and the external space.
